(19) United States
(12) Patent Application Publication
(10) Pub. No.: US 2008/0298600 A1
(43) Pub. Date: Dec. 4, 2008

(54) AUTOMATED REAL SPEECH HEARING INSTRUMENT ADJUSTMENT SYSTEM

(76) Inventors: Michael Poe, Seminole, FL (US); Anthony Quick, Orlando, FL (US); Srinivas Chari, Winter Springs, FL (US); Don E.K. Campbell, Winter Springs, FL (US)

Correspondence Address: ICE MILLER LLP, ONE AMERICAN SQUARE, SUITE 3100, INDIANAPOLIS, IN, 46282-0200, US

(21) Appl. No.: 12/106,893

(22) Filed: Apr. 21, 2008

Related U.S. Application Data
(60) Provisional application No. 60/925,623, filed on Apr. 19, 2007.

(51) Int. Cl. H04R 29/00

(52) U.S. Cl. 381/60

(57) ABSTRACT

A method for fitting a hearing instrument comprises placing the hearing instrument in situ includes receiving an audiogram of the user, determining a target gain for the hearing instrument as a function of the audiogram, exposing a reference sensor located adjacent the hearing instrument to an external speech signal, measuring an external sound pressure level (SPL) via the reference sensor, exposing a probe sensor coupled to the inside of the ear to the output of the hearing instrument while the hearing instrument is in situ, measuring an internal sound pressure level (“SPL”) inside the ear of the user via the probe sensor, determining an offset gain as a function of the external SPL, the target gain and the internal SPL, and automatically adjusting a gain of the hearing instrument according to the offset gain. A system for automatically fitting a hearing impaired person with a digital hearing aid in situ includes a digital hearing aid, a reference volume sensor, a probe sensor, a sound mapping module and a parameter control module.

This application claims priority to U.S. Provisional application 60/925,623 filed Apr. 19, 2007 the disclosure of which is incorporated herein by this reference.

### BACKGROUND AND SUMMARY

This disclosure relates to systems and methods of fitting hearing devices and more particularly to systems and methods of fitting hearing devices wherein measurements of the output of the hearing device are taken within the ear of the intended wearer of the hearing device.

In regards to the human auditory system, hearing aid devices (“hearing instruments”) are often used to compensate for hearing loss. The primary function of hearing instruments is to amplify the incoming signal in a manner appropriate to make the signal audible to the user. The amount of signal amplification may differ at various frequencies, normally audible to the human ear, based upon the degree of hearing loss at each frequency. Another important function of a hearing instrument is to limit the amplification of the incoming sound to a level that is not intolerable or uncomfortable to the user of the instrument.

Improving the audibility of human speech is the most important function of a hearing instrument. The hearing instrument's parameters affecting the amount of amplification and the limits of amplification are often adjusted to emphasize the speech signals that contribute most to the comprehension of human speech. Various frequency bands that are known to contain more useful speech information are emphasized or amplified more than other frequency bands containing less speech information.

A majority of hearing instruments currently fit to the human ear are both digital and programmable. These instruments have a multitude of parameters that are adjustable. These parameters are adjusted utilizing a computer or other hardware device, software dedicated to a particular manufacturer's hearing aid device, hardware that allows communication between the computer and the hearing aid device (such as HIPRO or NOAH LINK made by G. N. Otometrics ), and a cable that connects the hardware to the hearing instrument. Adjusting these parameters to best benefit the user may be done by the dispenser of the device. The dispenser uses manufacturer provided guidelines, “first fit” or “best fit” protocols, fitting help guides, and in ear measurements, as well as their professional judgment, and subjective comments from the user, or any combination of the these tools to adjust the hearing instrument in an attempt to improve the audibility and comfort of speech signals as determined by the hearing loss of the user.

Hearing instruments have been designed based on the “average ear,” and do not take into account the structural differences among individual ears. Therefore, if a hearing instrument is used on an ear that differs structurally from the average ear, the hearing instrument could produce an insertion response that is substantially different from what one would expect based on average ear data. In addition, the measured insertion response may not match the target response. The many factors that contribute to actual response curves differing from prescriptive target curves include pinna effects, microphone placement, unusual external ears (concha, shape and size), and/or eardrums, abnormal middle-ear compliance (normal, flaccid, stiff), ear canal volume (length/diameter/shape), hearing instrument shell/earmold material (hard, soft), insertion depth, vent diameter and length, and resonant frequency of the user's ear canals.

Prescriptive procedures to determine the proper amount of gain, or sound pressure level (“SPL”) for hearing aids have been used as far back as 1960. The amount of gain adjustments suggested by the manufacturer's software to optimize the audibility and comfort of the incoming signal for the user of the hearing instrument is based on “average ear” canal and pinna resonance values. Analyzing tools have been developed to provide the dispenser with better information about the amount of frequency-specific amplification a hearing aid is providing to a specific user. These analyzing tools utilize a probe tube that is inserted into a hearing instrument user's ear canal between the hearing instrument and the patient's ear drum to measure the amount of hearing instrument output in an effort to provide the dispenser some degree of “real” ear instead of “average” ear information. Some of these analyzing tools produce simple or complex tones at various frequencies as input to the hearing aid device, which is then measured as output in the ear canal.

More recently, analyzing tools have been developed that utilize recorded or live speech as the input signal, such as the MedRx Avant™ REM Speech System. These devices provide the dispenser a better understanding of the audibility and comfort of important amplified speech signals.

The dispenser of a hearing instrument currently can use information derived from speech mapping analyzing tools and the various programmable parameters of the hearing aid device to manually adjust the device. These manual adjustments are undertaken in an attempt to provide the user of the device with improved speech audibility and comfort. These manual adjustments require professional knowledge and an understanding of the correct manual manipulations required in each hearing aid manufacturer's software. Because the adjustments are made manually, they are time consuming and therefore can contribute to the cost of a hearing aid device and possibly decrease the amount of time the dispenser has available to counsel the hearing instrument user about the care and use of the instrument. If the dispenser lacks sufficient experience, the adjustments may not be completed properly. As a result, the hearing instrument user might not receive the full benefit from the use of the device and/or may refuse to wear the instrument.

Thus, hearing instrument manufacturers, sellers and users would appreciate a system and method that facilitate automatically fitting hearing instruments to a user that senses the in ear response of the hearing instrument to speech stimuli and adjusts controllable parameters of hearing instrument.

According to one aspect of the disclosure, a method for automatically fitting a hearing instrument while the hearing instrument is worn by a user listening to a speech signal includes receiving an audiogram of the user, determining a target gain for the hearing instrument as a function of the audiogram, placing the hearing instrument in situ, exposing a first microphone located outside an ear of the user to the speech signal and a second microphone coupled to the inside of the ear to the output of the hearing instrument, measuring a first sound pressure level (SPL) outside the ear via the first microphone, measuring a second SPL inside the ear of the user via the second microphone, determining an offset gain as a function of the first SPL, the target gain and the second SPL, and adjusting a gain of the hearing instrument according to the offset gain.

According to another aspect of the disclosure, a method for fitting a hearing instrument comprises placing the hearing instrument in situ includes receiving an audiogram of the user, determining a target gain for the hearing instrument as a function of the audiogram, exposing a reference sensor located adjacent the hearing instrument to an external speech signal, measuring an external sound pressure level (SPL) via the reference sensor, exposing a probe sensor coupled to the inside of the ear to the output of the hearing instrument while the hearing instrument is in situ, measuring an internal sound pressure level (“SPL”) inside the ear of the user via the probe sensor, determining an offset gain as a function of the external SPL, the target gain and the internal SPL, and automatically adjusting a gain of the hearing instrument according to the offset gain.

According to another aspect of the disclosure, a system for automatically fitting a hearing impaired person with a digital hearing aid in situ includes a digital hearing aid, a reference volume sensor, a probe sensor, a sound mapping module and a parameter control module. The digital hearing aid includes a digital signal processor and an interface for receiving instructions to the digital signal processor to modify parameters applied during the digital signal processing which affect the output of the hearing aid. The reference volume sensor is configured for positioning adjacent the hearing aid to receive external sounds from a speech stimulus and to output a signal indicative of the volume of the speech stimulus over a range of frequencies. The probe sensor is configured to output a signal indicative of the in ear volume level produced by the speech stimulus over a range of frequencies. The sound mapping module runs on a processor communicating with the reference volume sensor and the probe sensor and configured to receive the signals indicative of volume over a range of frequencies therefrom and store values generated from the signal indicative of the sensed volume at various frequencies within the ranges of frequencies. The parameter control module runs on a processor communicating with the sound mapping module for receiving the stored values generated from the signal indicative of the sensed volume at various frequencies within the ranges of frequencies and coupled to the interface of the hearing instrument for providing instructions to the digital signal processor to modify parameters applied during the digital signal processing.

Additional features and advantages of the invention will become apparent to those skilled in the art upon consideration of the following detailed description of a preferred embodiment exemplifying the best mode of carrying out the invention as presently perceived.

### BRIEF DESCRIPTION THE DRAWINGS

The invention can be better understood with reference to the following drawings and description. The components in the figures are not necessarily to scale, emphasis instead being placed upon illustrating the principles of the invention. In the drawings:

FIG. 1 is a functional block diagram of a real ear, real speech hearing instrument adjustment system;

FIG, 2 is a diagram of a speech mapping system coupled with an ear;

FIG. 3 is functional block diagram of a parameter control system;

FIG. 4 is a functional block diagram of a digital signal processor (DSP) for a hearing instrument;

FIG. 5 is a flow chart of a method for adjusting hearing instrument parameters;

FIG. 6 is a flow chart of a method for measuring and adjusting for feedback;

FIG. 7 is a flow chart of a method for measuring and adjusting for an occlusion effect;

FIG. 8 is a flow chart of a calibration routine for determining a real ear occluded response of a hearing device to identify frequencies that do not need to be amplified by the hearing device;

FIG. 9 is a flow chart of a routine that employs a floating stimulus adjustment to accommodate input stimuli with varying volumes;

FIG. 10 is a flow diagram of a portion of the method of adjusting hearing instrument parameters shown in FIG. 5 with the floating stimulus adjustment routine of FIG. 9 incorporated therein;

FIG. 11 is a flow diagram of a portion of the of adjusting hearing instrument parameters utilizing a method of detecting and reducing feedback wherein the feedback control in the hearing instrument is not disabled.

### DETAILED DESCRIPTION

A system and method that automatically adjust the parameters of a digital, programmable hearing instrument utilizing information derived from the results of speech mapping are presented. As used herein “speech” (unless specifically indicated otherwise) refers to live speech, pre-recorded speech signals, speech and noise signals, music signals and/or speech-like stimuli, calibrated stimuli, pure tones, random speech noise or other complex audio signals.

In one embodiment of the disclosed system and method, the dispenser or fitter of the hearing instrument obtains information through the use of a speech mapping system. The information obtained from the use of the speech mapping system is specific to the performance of the hearing instrument, the resonance of the user's external auditory canal and pinna, and the instrument user's hearing loss. Embodiments of the disclosed system and method utilize the hearing instrument manufacturer's fitting software and the information obtained from the use of the speech mapping system to automatically adjust the instrument's various controllable parameters. These adjustments are based on protocols developed by the manufacturer to best manipulate the various adjustable parameters of their own product so that incoming speech sounds are audible and tolerable to the actual user of the instrument.

One embodiment of the disclosed system and method automatically adjusts gain and/or phase cancellation to reduce feedback and/or the occlusion effect. Other embodiments of the disclosed system and method may adjust any adjustable parameter of the hearing instrument, such as the entrainment level, to increase the added stable gain of the hearing device and or the dynamic range of the patient. According to one embodiment of the disclosed system and method, the above described adjustments may all be made without requiring a product specific expertise of the dispenser.

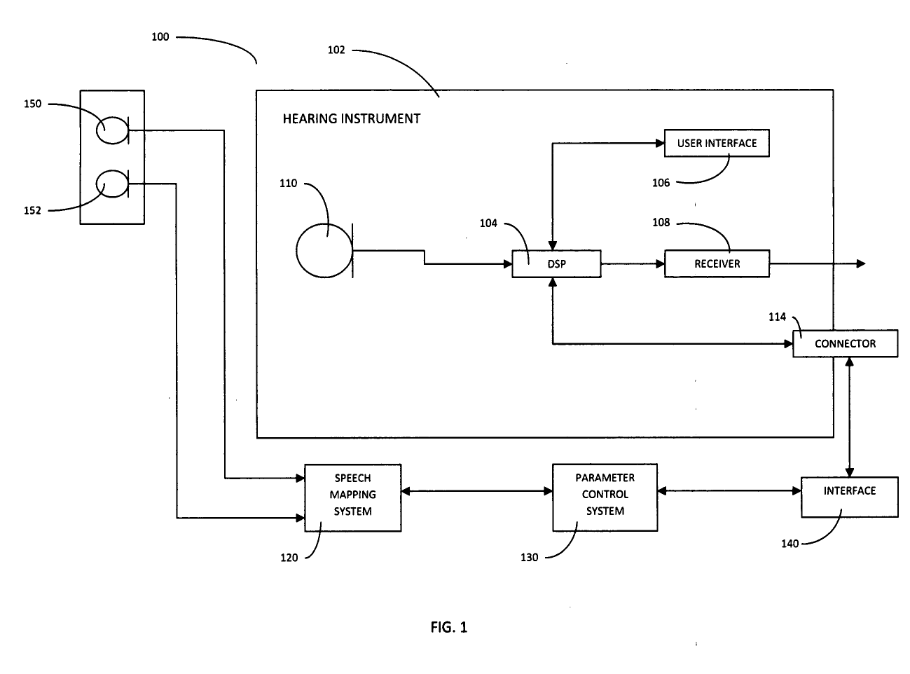

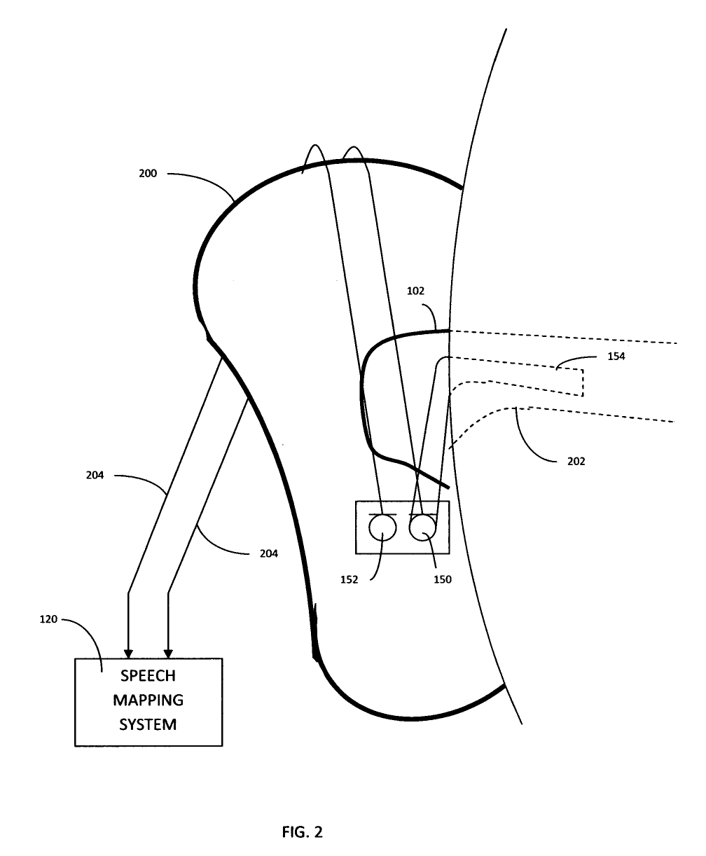

As shown in FIG. 1, one embodiment of the disclosed system 100 includes a hearing instrument 102, a speech mapping system 120, a parameter control system 130, an interface 140, a probe microphone 150 and a reference microphone 152. The speech mapping system 120 is coupled with the parameter control system 130 and the probe and reference microphones 150, 152, respectively. The parameter control system 130 is coupled with the hearing instrument 102 via an interface 140. The interface 140 is coupled to a connector 114 on the hearing instrument 102. The hearing instrument 102, speech mapping system 120, parameter control system 130, interface 140 and probe and reference microphones 150, 152, respectively may communicate among each other using any type of electromagnetic communications via an electromagnetic channel or network, including microwave, RF, FM, optical, Bluetooth, whether wired or wireless, USB cable, CS 44 cable or other well-known means.

As shown, for example, in FIG. 2, in one embodiment of the disclosed system, the microphones 150 and 152 are located on the outside of the user's ear 200. For example, they may be suspended in front of the ear via the cables 204. For example, the probe and reference microphones used in the MedRx Avant™ REM Speech System, available from MedRx, Inc. of Largo, Fla. may be utilized within the scope of the disclosure to implement the microphones 150, 152. The probe microphone 150 measures the sound pressure level (“SPL”) in the ear after sound has been amplified by the hearing instrument 102. To accomplish this, the probe microphone 150 is connected to a tube 154 that is inserted into the ear canal 202 of the user's ear 200. The reference microphone 152 measures the SPL before the sound is amplified by the hearing instrument 102. While a probe microphone 150 connected to a tube having an opening within the ear canal is shown and described as the sensor for measuring the sound pressure level in the ear of the user, it is within the scope of the disclosure for other sensors, such as an in ear microphone or other sound or pressure sensor or even a microphone component of the hearing instrument itself to be utilized as the sensor for detecting the sound pressure level. Additionally, some other measurement indicative of how well the output of the hearing device is adjusted for the specific user may be utilized within the scope of the disclosure to measure the in ear response of the hearing instrument 102. While a reference microphone 152 is described as the sensor for measuring the sound pressure level outside the ear of the user, it is within the scope of the disclosure for other sensors, such as another sound or pressure sensor or even a microphone component of the hearing instrument itself to be utilized as the sensor for detecting the sound pressure level. Additionally, some other measurement indicative of the volume of a reference sound input may be utilized within the scope of the disclosure to detect the external stimulus levels.

The speech mapping system 120, along with the microphones 150, 152, obtains the gain of the hearing instrument 102 over time. This time domain signal is converted into a frequency domain signal using a fast Fourier transform (“FFT”) to obtain the gain as a function of frequency. The gain is determined as the difference between the SPL inside the ear (as measured by the probe microphone 150) and the SPL outside the ear (as measured by the reference microphone 152). From this information, the speech mapping system such as the Med RX Advant™ REM Speech System can determine the gain that the hearing instrument should provide (the “target gain”). The speech mapping system 120 may include a memory, processor and a user interface (not shown). It is within the scope of the disclosure for the fourier transform and or the gain calculation to be carried out by other illustrated components or additional components of the system, such as, for example, by processors and memory of the hearing instrument, or by the processor 302 and memory 304 of the parameter control system 130.

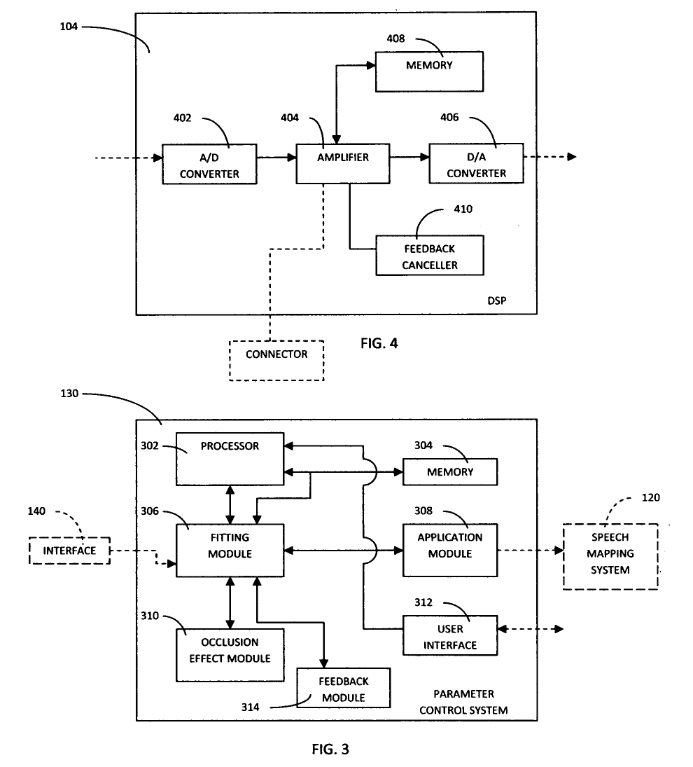

As shown in FIG. 3, the parameter control system 130 generally includes a processor 302, a memory 304, a fitting module 306, an application module 308 and a user interface 312. The application module 308 and the fitting module 306 determine the required gain adjustment. Based on information received from the speech mapping system 120, the application module 308 and the fitting module 306 determine the required gain adjustment and communicate the adjustment to the hearing instrument 102. In addition, the parameter control system 130 may include an occlusion effect module 310 and/or a feedback module 314. These modules can adjust the gain to reduce the effects of occlusion and/or feedback, respectively. The gain adjustment is communicated to the hearing instrument 102 through an interface 140, such as a HIPRO Box made by G.N. Otometrics.

The hearing instrument 102 basically includes microphone 110, a digital signal processor (“DSP”) 104, a receiver 108, a user interface 106 and a connector 114, as shown, for example, in FIG. 1. In addition, the hearing instrument 102 may include a feedback canceller 410, as shown, for example, in FIG. 4. When the hearing instrument 102 is in use, the microphone 110 receives sound signals present at the user's ear, which are then manipulated by the DSP 104 and outputted to the user by a receiver 108. As shown, for example, in FIG. 4, the DSP 104 generally includes an analog-to-digital (“A/D”) converter 402, an amplifier 404, a digital-to-analog (“D/A”) converter and a memory 408. The A/D converter 402 converts the sound signal into a digital signal, the amplifier 404 manipulates the sound in terms of gain and the D/A converter 406 converts the digital signal back into a sound signal that can be heard by the user via the receiver 108. The memory 408 may store protocols or routines for adjusting the parameters, such as gain, of the hearing device 102. These routines may be saved in the memory of the hearing instrument 408 incorporated by the manufacturer of the hearing instrument 102. The DSP 104 may also include modules that make other adjustments to the digital signal, such as modules to reduce noise and improve signal-to-noise ratios.

The user interface 106 may include a volume control (not shown) and a memory for storing preset parameters, such as gain and volume, which are designed for use in different listening environments. For example, if the user works in a factory with loud background noise, well-known noise reduction algorithms can be employed which are selectively engaged and disengaged by the user after the hearing instrument has been fitted according to one embodiment of the disclosed system 100.

The hearing instrument 102, speech mapping system 120, parameter control system 130 and the interface 140 may be implemented in a combination of hardware and computer-executable software. The processors may include any type of device or devices used to process digital information. Each of these components may include or be in communication with one or more processors and/or computer-readable memories. The memories may include any type of fixed or removable digital storage device and, if needed, a device for reading the digital storage device, including floppy disks and floppy drives, CD-ROM disks and drives, optical disks and drives, hard-drives, RAM, ROM and any other device or devices for storing digital information. The software may include object code, source code, or any computer-readable code, and may be stored in the one or more processors, and/or memory devices in any combination.

The user interface 312 of the parameter control system 130 and the user interface of the speech mapping system 120 (together the “user interface systems”) may include any appropriate type of user interface for any type of computer, electronic device or terminal capable of digital communication. The user interfaces may include an input device and an output device (not shown). The output device may include any type of visual, manual, audio, electronic or electromagnetic device capable of communicating information from a processor or memory device to a person or other processor or memory device. Examples of output devices include, but are not limited to, monitors, speakers, headphones, liquid crystal displays, networks, buses, and interfaces. The input device may include any type of visual, manual, mechanical, audio, and/or electromagnetic device capable of communicating information from a person or memory to a processor or memory. Examples of input devices include keyboards, microphones, voice recognition systems, trackballs, mice, networks, buses, and interfaces. The input and output devices may be included in a single device such as a touch screen, computer, processor or memory device.

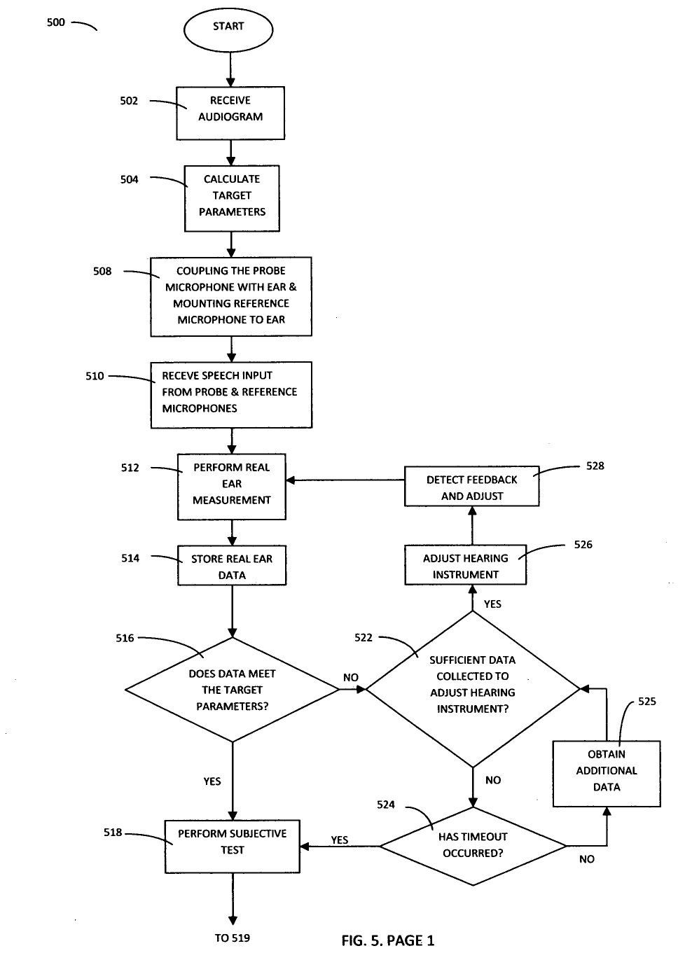

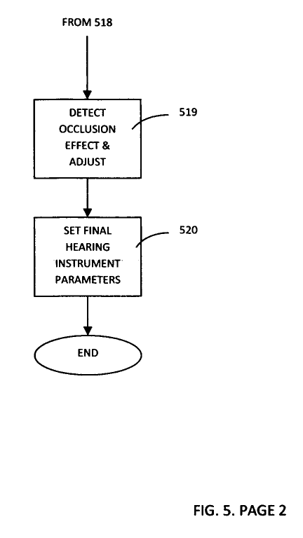

One embodiment of a method 500 for adjusting the parameters of a hearing instrument is shown in FIG. 5. Embodiments of the disclosed adjustment method 500 may include making real ear measurements of the in-ear sound pressure level with speech as the input and automatically adjusting the hearing instrument parameters, such as gain, based on the real ear measurement. The description that follows will make reference to FIGS. 1, 3 and 4, in addition to FIG. 5 in describing the illustrated embodiment of adjustment method 500.

Initially, the application module 308 of the parameter control system 130 receives a pre-measured audiogram via the fitting module 306 or other source such as an automated audiometer. The audiogram is then communicated with the speech mapping system 120. Then, in step 504, the speech mapping system 120 calculates the target parameters from the audiogram using a technique such as, Speech Banana, NAL-NLI and DSL I/O. This calculation is made over a range of frequencies for one or more sound pressure levels. In one embodiment of the system and method, the target parameters are calculated for frequencies from about 20 Hz to about 20,000 Hz. In one embodiment of the system and method, the target parameters are calculated for frequencies from about 125 Hz to about 8,000 Hz, the typical range of human speech. In one embodiment the target parameters are calculated for a sound pressure level of normal speech, such as about 65 dB SPL. Target parameters for other sound pressure levels may be extrapolated from these calculated target parameter values utilizing standardized formulas, such as, for example, formulas provided by NAL-NLI standards. In one embodiment of the disclosed system and method, the target parameters are calculated for three different power levels, such as 50, 65 and 80 dB SPL producing three sets of target data, one for each power level.

The speech mapping system 120 communicates the target data to the application module 308 of the parameter control system 130. Target data provided by well known standards is often provided only for certain frequencies, for example, target data is sometimes provided only for octave values (e.g. 125 Hz, 250 Hz, 500 Hz) at low frequencies and at half octave values (e.g. 2000 Hz, 3000Hz, 4000 Hz 6000 Hz, 8000 Hz) at higher frequencies). Because the resolution of the target data may not be the same as that for the gain measurements, the application module 308 interpolates the target data to fit the resolution of the measured gain.

To begin the gain measurements, the hearing instrument 102 is coupled with the ear 200 of the user and the probe and reference microphones 150, 152, respectively, are placed near the outside of the ear 200 in step 508. In addition, the probe microphone 150 is coupled with the inside of the ear canal 202 via a tube inserted into the canal. In step 510 a speech signal is produced by a person speaking to or in the vicinity of the user and/or by playing a recording of speech in the vicinity of the user. The reference microphone 152 detects the SPL of the speech signal before the speech signal is manipulated by the hearing instrument 102 and the probe microphone measures the SPL of the speech signal within the ear 200 (“in-ear SPL”) after the speech signal has been manipulated by the hearing instrument 102. The microphones communicate the measured SPLs to the speech mapping system 120.

In step 512, the speech mapping system 120 performs a real ear measurement and communicates the measurements with the application module 308 of the parameter control interface 130. In one embodiment of the disclosed system and method, the real ear measurements are continuously communicated. The speech mapping system 120 measures the in-ear SPL, over time, so that the application module 308 may capture the SPL of various types of speech. For example, speech varies in terms of pitch and volume. Therefore, in one embodiment of the disclosed system and method, the reference microphone 152 is exposed to the speech signal over time so that the application module 308 may capture the in-ear SPL, which reflects a variety of frequencies and power levels. For example, the application module 308 may look to capture different sound pressure levels that correspond to loud, conversational and soft speech signals. A sound level of about 50 dB SPL ± about 3 dB may be used to represent soft speech, a sound level of about 65 dB SPL ± about 3 dB may be used to represent a conversational level of speech and a sound level of about 80 dB SPL ± about 3 dB may be used to represent loud speech.

In step 514, the parameter control module 130 stores the captured in-ear SPL in memory 304. For example, memory 304 may include a register into which the in-ear SPL is stored. In addition, the application module 308 may calculate an offset value as the difference between the target gain and the in-ear SPL and store the offset values in an offset register in memory 304. Because the in-ear SPL is measured over time, multiple values for a given frequency and power level may be obtained. In this case, in one embodiment of the disclosed system and method, the parameter control module 130 averages the in-ear SPL corresponding to the multiple values and stores the average in memory 304. Other statistical and data management methods may be utilized within the scope of the disclosure for storing multiple sensed SPL values for a particular frequency as a single representative SPL value for the particular frequency, such as the peak SPL, a normalized value, a median value, a peak value, etc. This helps to reduce the number of outliers to increase the amount of valid data points.

In step 516, the application module 308 determines if the in-ear SPL meets the target gain for the hearing instrument 102. In one embodiment of the disclosed system and method, to determine if the in-ear SPL meets the target gain for the hearing aid, the application module 308 compares the in-ear SPL with the target values and determines whether the in-ear SPL is sufficiently close to the target values. For example, the comparison can be made using two or more cycles, and if a ±2 dB SPL change in levels or less is seen, or if no further improvements in the target gain are possible without generating feedback or other adverse side effects can be made, the gain values for the last cycle maybe accepted. It is within the scope of the disclosure for the acceptable variation of the sensed gain from the target gain to be increased after several cycles, for example, to ±3 dB after four cycles and to ±5 dB after six cycles. Other methods of varying gain or other hearing aid responses may also be employed, such as changes in threshold knee points and/or compression ratios at certain frequencies or inputs, or other adjustments to hearing aid outputs. If the in-ear SPL meets the target gain, the gain is verified and adjusted as necessary according to a subjective test administered to the user.

If the measured in-ear SPL does not meet the target gain, the fitting module 306 of the parameter control system 130 determines whether there is sufficient valid SPL data with which to adjust the gain of the hearing instrument 102 in step 522. In one embodiment of the disclosed method, if there is insufficient data to adjust the gain of the hearing instrument 102, the parameter control module 130 waits to see if enough of the missing data is captured to allow an adjustment of the gain.

If, in step 524, a predetermined amount of time has passed or a predetermined number of measurements have been made, a “timeout” is said to have occurred and the application module 308 stops storing data. In at least one embodiment of the disclosed system and method, a “timeout” is not implemented. In embodiments of the disclosed system and method implementing “timeouts”, the utilization of “timeouts” may speed up the test or to solve a “lack of data” problem. In one embodiment of the disclosed system and method, a “timeout” may also, or alternatively, be implemented by the speech mapping system 120 which collects data and sends it to the parameter control system. In other words, any data collecting could use statistics to “fill gaps” or “timeout” to apply a stop point and fill in data. At this point, the parameter control module 130 may use the data that has been captured to adjust the hearing instrument in step 526.

Alternately, the parameter control module 130 may attempt to capture additional in-ear SPL data points. In other embodiments, the missing data may be extrapolated from the neighboring frequency data points, a subsequent forced presentation of speech can be done with alternative loud or soft voices, or an automated fitting with pre-recorded stimuli that could be automatically generated by the parameter control system 130 based on the types of frequencies or bands that were missing data from the measuring process. The parameter control system 130 may prompt the user or fitter to read from a word list that would be likely to obtain the missing data. For instance, if for some high frequency bands not enough data is captured, the parameter control system 130 may prompt the user or other individual to say a phrase such as, “She Sells Sea Shells on the Sea Shore.”

If, in step 522, the fitting module 306 determines that there is sufficient data to adjust the hearing instrument 102, the fitting module 306 adjusts the gain of the hearing instrument 102, via the interface 140, by the offset amount. Thereafter, the process begins again at step 512 and repeats until the data meets the target gain in step 516.

Once the target gain is met, the gain is verified and adjusted as necessary according to subjective test(s) administered to the user. For example, the dispenser can conduct a word recognition test well known in the industry and measure the accuracy of the user's response. The dispenser or a person of interest can engage in normal conversation or read to the user from selected word lists or text.

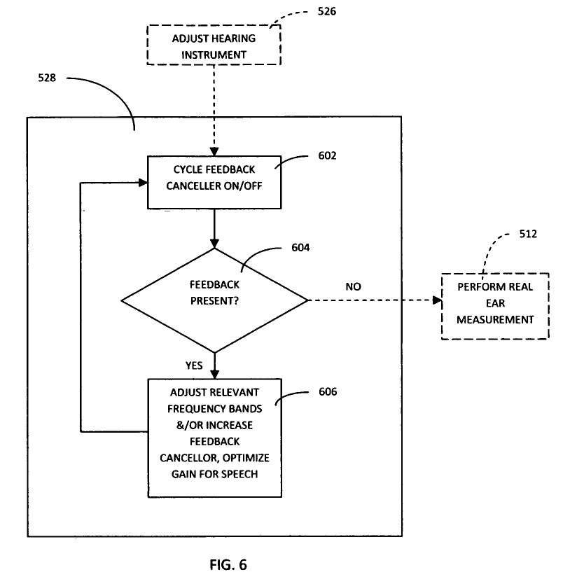

Optionally, it is expected that the System 100 may detect feedback and adjust the gain and/or phase cancellation to minimize any detected feedback in step 528, one embodiment of which is shown in more detail in FIG. 6. To determine whether there is feedback present, the feedback canceller 410 of the hearing instrument may be cycled on and off in step 602. The speech spectrum is measured as a function of frequency when the feedback canceller 410 is on and when it is off. These two spectrums are subtracted one from the other and the peaks of the resulting difference are analyzed to determine the frequencies at which feedback, if any, occurs. For example, peaks of the resulting difference, which are greater than 6 dB, may be used to identify the frequencies at which feedback occurs. If feedback is detected in step 604, the appropriate adjustments are made to the gain at the frequencies at which the feedback occurs and/or the feedback canceller is increased in step 606. In this manner, feedback is reduced while preserving gain as much as possible. After the adjustments are made in step 606, the process repeats from step 602 until it is determined that the feedback can no longer be detected, at which point the entire process repeats from step 512.

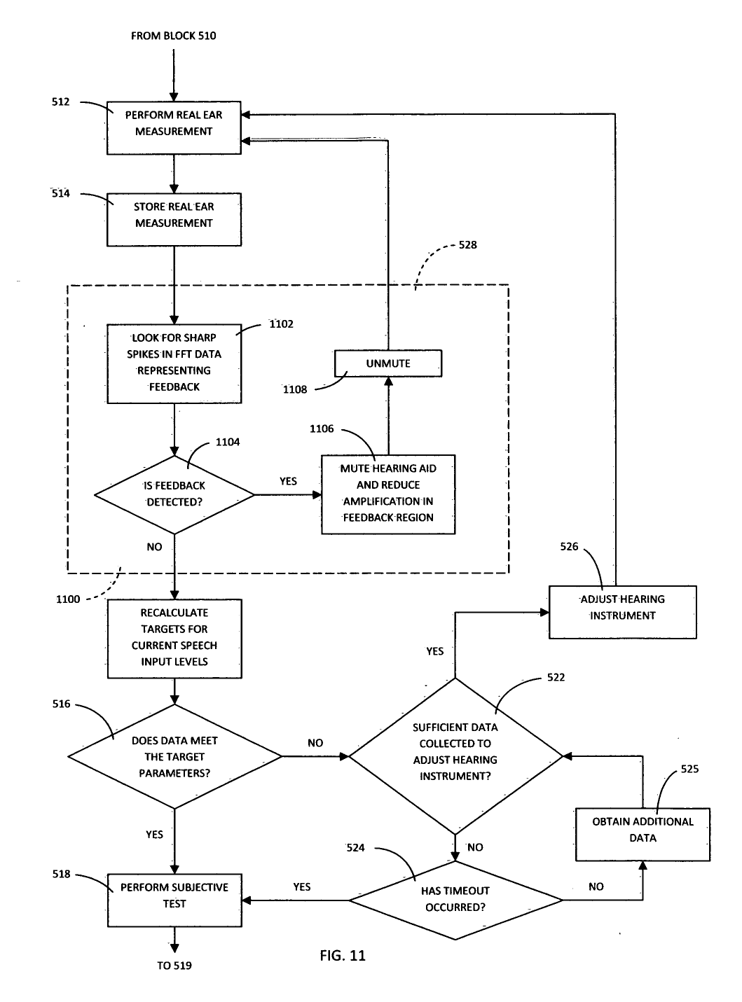

In another embodiment 1100 of the step 528 of minimizing feedback, as shown, for example, in FIG. 11, the speech mapping module is configured to detect spikes, or other indicators of feedback, in the in-ear SPL data in steps 1102 and 1104. In step 1102, the real ear measurements are examined to determine if sharp spikes occur in the fast fourier transformation data. As part of the automation routine, the speech mapping from the in-ear or canal resonance data may be deemed to indicate feedback if the peak SPL is higher than the long term average in a given frequency region in step 1104.

In one embodiment, upon detecting an indication of feedback from examination of the in-ear SPL data, the output of the hearing device is immediately muted in step 1106 to minimize discomfort to the user. In one embodiment, the exterior SPL data is examined to determine if a false feedback indication has been detected, such as when an external sound source shows unusual SPLs in the frequency of the detected feedback, for example, someone in the room where the fitting is being conducted may have whistled or some device may have generated a loud noise. If an external input is determined to have generated the indicator of feedback, the disclosed system and method may make no adjustments to the gain or feedback cancellation levels of the hearing device.

If the feedback indication is deemed to be true feedback, in one embodiment of the disclosed system and method, the gain of the hearing device in the frequency range at which an indication of feedback has been detected is reduced in step 1106. In one embodiment the gain in the appropriate band(s) is reduced by 12 dB. It is within the scope of the disclosure to reduce the gain in the appropriate bandwidth by other amounts in an effort to reduce or eliminate feedback. Following the gain reduction in the frequency band(s) where feedback was indicated the hearing device is turned on again in step 1108 and the process is repeated continuing to reduce gain in the band in which feedback is detected until feedback is no longer detected. If at any time, it is determined that the indication of feedback was the result of false feedback, the gain is restored to prior levels in the frequency in which feedback had been detected. Those skilled in the art will recognize that if the hearing device includes a feedback phase cancellation module, instead of decreasing gain when feedback is detected, the phase cancellation may be increased to eliminate feedback. Many devices, including external microphones 152 or other external devices may be utilized to detect false feedback within the scope of the disclosure.

One advantage of the immediately above described embodiment 1100 of the feedback reduction step 528 is that the feedback control in the hearing instrument is never disabled, facilitating the attainment of the maximum added stable gain that the given feedback canceling algorithm of the measured hearing instrument is capable of producing. It also increases patient comfort by quickly eliminating the feedback in the ear canal. If the offset gains in the feedback region indicate that the target gain cannot be attained without inducing feedback, the decision may be made to stop attempting to increase the gain beyond the level at which the onset of feedback is detected. Thus, the described feedback method facilitates maximizing the dynamic range of the patient while considering the maximum capabilities of the feedback canceller of the instrument at the same time.

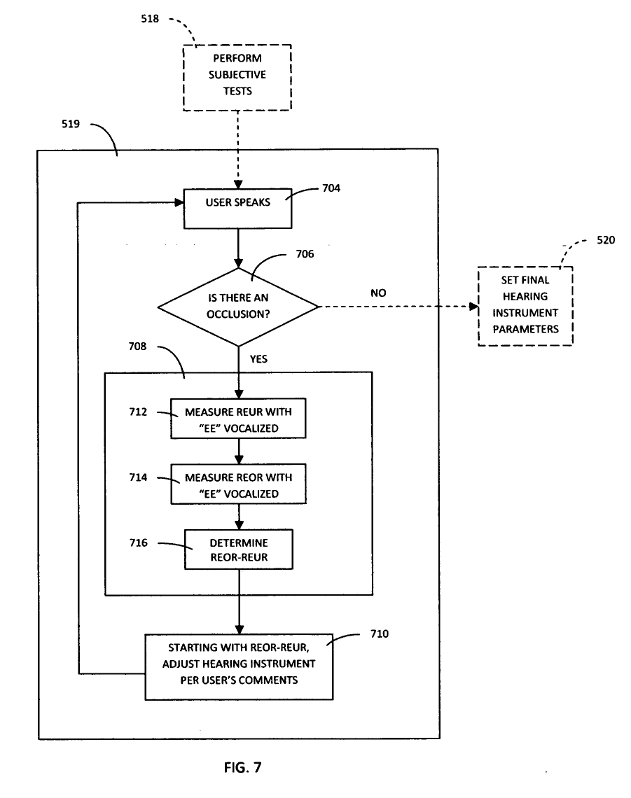

In one embodiment of the disclosed system and method, the gain may be adjusted to minimize the occlusion effect in step 519, which is shown in more detail in FIG. 7. After, or as part of the subjective test performed in step 518, the user speaks in step 704 and based on how the user's voice sounds to him or her, determines whether there is an occlusion in step 706. If the user detects an occlusion, the occlusion is measured in step 708 and the hearing instrument is adjusted to reduce the occlusion in step 710.

It is expected that measuring the occlusion effect may include measuring the real ear unoccluded response (“REUR”) as the user vocalizes the sound “EE” in step 712, measuring the real ear occluded response (“REOR”) as the user vocalizes the sound “EE” in step 712 and determining the difference between REOR and REUR in step 716. The gain of the hearing instrument is adjusted in step 710, starting with REOR-REUR, according to the user's comments. The process then repeats from step 704 until the occlusion effect is reduced to an amount that is tolerable to the user. After this point is reached, the entire process continues at step 520.

As indicated above, the disclosed automatic hearing instrument fitting system permits live speech to be used to fit the hearing aid to the subjective needs of the patient, including the patient's own speech. In addition, the live voice of spouses, relatives or other persons of interest may also be used to fit the hearing aid to the important sources of communication to the patient in daily life. Use of speech as a parameter of the automatic fitting process will also permit the dispenser to employ languages other than his or her native language in the fitting process via pre-recorded audio types, disks or live speech of third parties. In addition, the dispenser can present, via pre-recordings or providing lists of words or sounds to be heard by persons at the fitting, a wide variety of sounds and frequencies, some of which may be used to obtain data points for soft sounds and high frequencies. It is also contemplated that other complex audio signals, such as music, or voice or music in combination with replicated noise inherent in the patient's expected work environment could be employed as the input signal and used to fit the digital hearing instrument according to the disclosure.

Thus, the disclosed automatic fitting systems use speech, including live speech, to achieve the desired fitting for the individual patient, taking into account the patient's subjective responses and physiological conditions to achieve a hearing instrument output that closely mirrors the desired input sounds and voices for that patient from the patient's environment and perspective. Use of the occlusion modules and/or feedback modules of the disclosed system and method further increases patient comfort and lessens undesired sounds during automatic fitting while the hearing aid is being worn by the patient and in subsequent use of the device by the patient outside the dispenser's offices. Applicants' expect that patients fitted according to the disclosure will make fewer return trips to the dispenser, and patients will be able to be fitted more quickly, more comfortably and/or with better precision than with prior systems.

By way of an example, a speech based automated hearing aid fitting system according to one embodiment of the present disclosure may be used to fit digital programmable hearing aids 102, such as in the ear (ITE), behind the ear (BTE), over the ear (OTE), open fitting or pocket hearing aids, such as a Monet 4D BTE or Evok 727 hearing aid made by Magnatone Hearing Aid Corporation, Casselberry, Florida. In one embodiment of the disclosed system, the interface device 140, such as a HIPRO Box, can be connected to the hearing aid 102 and the parameter control system 130, which may include software running on a desktop or laptop computer, such as a HP Pavillion 2D 8000 series laptop using Windows XP as its operating system. The parameter control system 130 may also be connected to the speech mapping system 120, such as a MedRx Avant REM speech system, to show live speech mapping. In one embodiment of the disclosed system, VoicePro software program (Magnatone Hearing Aid Corporation) can be used on the parameter control system 130 to adjust the speech map displayed on the computer screen to the desired gain for the patient wearing the hearing aid 102 and listening to the speech input. The patient is also wearing the reference microphone 152 attached to the hearing aid interface. In one embodiment of the disclosed system, a cable 204 connects the external reference microphone 152 located around ear lobe height and a probe microphone 150 coupled to a hearing probe 154 inserted into the patient's ear canal interconnected to the control system. In one embodiment of the disclosed system, the microphones 150, 152, probe 154 and cables 204 may be implemented using the MedRx Advant REM Speech system mentioned above. When the patient is presented with speech input sounds, the reference microphone 152 detects the input SPL and the probe microphone 150 detects the output SPL of the hearing aid 102 and transfers those signals via their cables 204 to the control system.

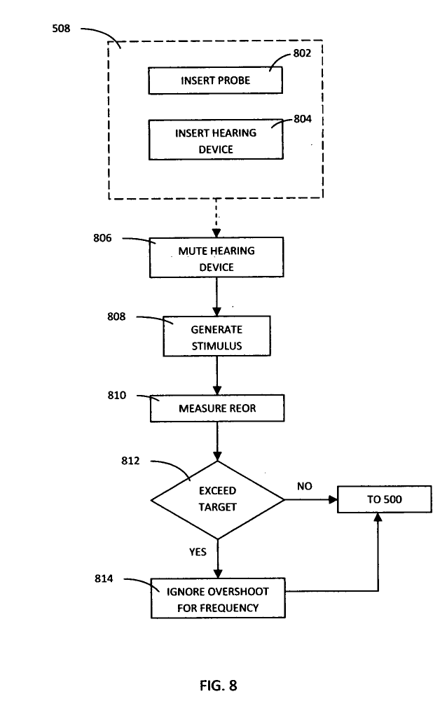

In one embodiment of the disclosed method, a calibration step 800, as shown for example, in FIG. 8, helps to determine which frequencies are getting “to the ear drum” or at least to the probe microphone 150 which are not a result of amplification from the hearing instrument 102. In one embodiment of this calibration step 800, the probe tube 154 coupled to the probe microphone 150 is inserted in the ear canal in step 802 and the hearing aid 102 is positioned in its use position in step 804. The hearing device is muted in step 806 and the desired stimuli is generated in step 808. The response in the ear canal to the non-amplified stimuli (REOR—real ear occluded response) are measured in step 810. In step 812 it is determined whether the measured response shows that the “pass through” energy is greater than the proposed target response (NAL-NLI for instance) for the frequencies to be tested and for which the gain can be adjusted for the hearing aid 102. If the pass through energy does not exceed the target response, the steps of method 500 may be completed. If the pass through energy is greater at some frequencies than the target response, then there is no way to subtract energy from the canal to reach target at those frequencies.

For example, especially with open fittings, or if a very large vent is needed, low frequency enters the ear canal naturally and passes through to the ear drum. Since low frequencies are often not amplified for hearing losses which are considered normal in the low frequencies, the SPL data from the probe microphone may exceed the target gain at some frequencies. Thus, the disclosed system and method may be configured to “ignore” apparent overshoots of the target gain in step 814 with regard to those frequencies at which the REOR—real ear occluded response indicates that the “pass through” energy is greater than the proposed target response. By ignoring these overshoots the system and method may avoid an endless loop when offsets are not reducing and achieving the target curve might be impossible.

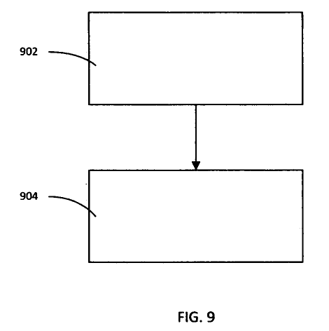

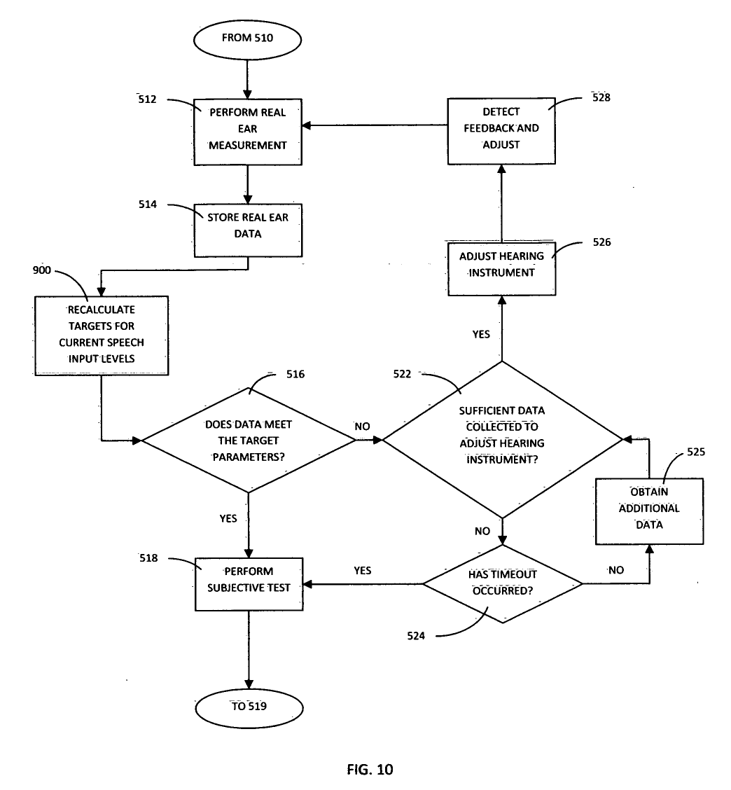

Those skilled in the art will recognize that live speech can not be presented at a fixed SPL. The human voice is too dynamic to present long term average speech at a consistent level. In order to ensure that tests are repeatable, one embodiment of the disclosed method and system employs a floating stimulus adjustment 900, as shown, for example, in FIGS. 9 and 10. As shown, for example, in FIG. 10, in one embodiment of the disclosed method 500, the floating stimulus adjustment 900 is performed after the real ear data is stored in step 514 and before it is determined whether the data meets the target parameter in step 516. In step 902, the input SPL is analyzed through the reference microphone 152. The target gains are recalculated for the measured input SPL in step 904. This ensures that the offset gain for all frequencies have the same reference point. Such approach increases the likelihood that the target gains will be repeatable when different stimuli, such as different speakers' voices, are utilized to fit the hearing device.

Data regarding the adjustments to, and/or final settings for, hearing devices from various manufacturers that have been fitted utilizing the disclosed automated real speech hearing instrument adjustment system and method may be stored in memory and linked to the manufacturer and model of the hearing device and/or to the audiogram for the user for whom the hearing device was fitted. Over time a large amount of data regarding the settings for and adjustments to each model of hearing device that has been fitted utilizing the disclosed automated real speech hearing instrument adjustment system and method may be developed. This archived data may be numerically or statistically manipulated to establish initial baseline settings for each model of hearing device that has been adjusted utilizing the automated real speech hearing instrument adjustment system and method. Such archived data may also be utilized to establish initial base line settings for each model of hearing aid by comparing audiograms for a user to be fitted with a hearing device to stored audiograms of users previously fitted with the same device. Utilization of these initial baseline settings may further reduce the time required to properly fit a user with a hearing device.

While the disclosed system and method have been described as utilizing a single standard (illustratively, the NAL-NLI standard) for determining a target formula, the automated nature of the disclosed system and method naturally lends itself to utilizing several different target formulas. Thus it is within the scope of the disclosure for an initial adjustment to be made to a hearing device utilizing a first target formula and further adjustments to be made utilizing a different target formula. In one embodiment, after an initial adjustment or fitting of a hearing device for a user using a first target formula and a word test or some other validation, a score for the adjustment is recorded. The hearing device is then re-fit to the same user utilizing a different target prescription utilizing the same validation as used in the initial adjustment. A score applying the same criteria as utilized to develop the score for the first adjustment is then recorded for the re-fit. The scores for the initial adjustment and the re-fit are compared and the hearing device is fitted utilizing the target formula which generated the better score. The re-fit target formula may in one embodiment consider different factors, such as age of the patient, years previously wearing a hearing instrument, cochlear damage, central issues of the brain, etc., than the first target formula. It is within the scope of the disclosure for a series of tests to be performed.

While various embodiments have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for automatically fitting a hearing instrument while the hearing instrument is worn by a user listening to a speech signal, the method comprising:
receiving an audiogram of the user;
determining a target gain for the hearing instrument as a function of the audiogram;
placing the hearing instrument in situ;
exposing a first microphone located outside an ear of the user to the speech signal and a second microphone coupled to the inside of the ear to the output of the hearing instrument;
measuring a first sound pressure level (SPL) outside the ear via the first microphone;
measuring a second SPL inside the ear of the user via the second microphone;
determining an offset gain as a function of the first SPL, the target gain and the second SPL; and
adjusting a gain of the hearing instrument according to the offset gain.

2. The method of claim 1 and further comprising adjusting the offset gain utilizing the measured first sound pressure level.

3. The method of claim 1 and further comprising detecting feedback at a frequency utilizing the second SPL and downwardly adjusting the gain of the hearing instrument in the frequency at which feedback is detected while leaving any feedback cancellation active.

4. The method of claim 3 and further comprising muting the output of the hearing aid after detecting feedback and prior to downwardly adjusting the gain of the hearing aid.

5. The method of claim 4 and further comprising unmuting the output of the hearing aid after downwardly adjusting the gain and repeating the exposing, measuring and detection of feedback steps.

6. The method of claim 1 and further comprising muting the output of the hearing instrument, measuring the real ear occluded response and identifying frequencies at which the hearing instrument need not amplify the input.

7. The method of claim 1 and further comprising performing a fast fourier transform on data generated during the measuring a first and a second SPL steps.

8. The method of claim 1 wherein the target parameters are calculated for at least two different power levels producing a set of target data for each of the at least two power levels.

9. The method of claim 1 and further comprising measuring the real ear occluded response to a speech signal generated by a speaking user.

10. A method for fitting a hearing instrument comprising:
placing the hearing instrument in situ;
receiving an audiogram of the user;
determining a target gain for the hearing instrument as a function of the audiogram;
exposing a reference sensor located adjacent the hearing instrument to an external speech signal;
measuring an external sound pressure level (SPL) via the reference sensor;
exposing a probe sensor coupled to the inside of the ear to the output of the hearing instrument while the hearing instrument is in situ;
measuring an internal sound pressure level (“SPL”) inside the ear of the user via the probe sensor;
determining an offset gain as a function of the external SPL, the target gain and the internal SPL; and
automatically adjusting a gain of the hearing instrument according to the offset gain.

11. The method of claim 10 and further comprising adjusting the offset gain utilizing the measured external sound pressure level.

12. The method of claim 10 and further comprising detecting feedback at a frequency utilizing the internal SPL and downwardly adjusting the gain of the hearing instrument in the frequency at which feedback is detected while leaving any feedback cancellation active.

13. The method of claim 12 and further comprising muting the output of the hearing instrument after detecting feedback and prior to downwardly adjusting the gain of the hearing instrument.

14. The method of claim 10 and further comprising measuring the real ear occluded response to a speech signal generated by a speaking user.

15. A system for automatically fitting a hearing impaired person with a digital hearing aid in situ comprising:
a digital hearing aid having a digital signal processor and an interface for receiving instructions to the digital signal processor to modify parameters applied during the digital signal processing which parameters affect the output of the hearing aid;
a reference volume sensor configured for positioning adjacent the hearing aid to receive external sounds from a speech stimulus and to output a signal indicative of the volume of the speech stimulus over a range of frequencies;
a probe sensor configured to output a signal indicative of the in-ear volume level produced by the speech stimulus over a range of frequencies;
a sound mapping module running on a processor communicating with the reference volume sensor and the probe sensor and configured to receive the signals indicative of volume over a range of frequencies therefrom and store values generated from the signal indicative of the sensed volume at various frequencies within the ranges of frequencies;
a parameter control module running on a processor communicating with the sound mapping module for receiving the stored values generated from the signal indicative of the sensed volume at various frequencies within the ranges of frequencies and coupled to the interface of the hearing instrument for providing instructions to the digital signal processor to modify parameters applied during the digital signal processing.

16. The system of claim 15 wherein the probe sensor includes a probe microphone configured for locating adjacent the hearing instrument and a probe tube configured to be received at least part in the ear of the hearing impaired person and in communication with the probe microphone.

17. The system of claim 16 wherein the reference sensor is a reference microphone.

18. The system of claim 15 wherein the sound mapping module is configured to identify frequencies in which feedback is present and the parameter control module is configured to mute the output of the hearing instrument in the frequencies at which feedback is detected prior to instructing the digital signal processor to reduce the gain for frequencies at which feedback has been detected.

19. The system of claim 15 wherein the sound mapping module is configured to perform a fast fourier transform on the signals indicative of volume over a range of frequencies prior to storing store values generated from the signal indicative of the sensed volume at various frequencies within the ranges of frequencies.

20. The system of claim 15 and further comprising memory configured to link frequency value information with sensed volume at various frequencies.
